(19) United States
(12) Patent Application Publication
(10) Pub. No.: US 2007/0269343 A1
(43) Pub. Date: Nov. 22, 2007

(54) DISPENSING APPARATUS

(75) Inventors: Akira HIGUCHI, Fukuoka (JP); Hideyoshi KITAHARA, Fukuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/751,279

(22) Filed: May 21, 2007

(30) Foreign Application Priority Data
May 22, 2006 (JP) 2006141188

(51) Int. Cl. G01N 31/00

(52) U.S. Cl. 422/65

(57) ABSTRACT

In fitting a plurality of tips 40 in a desired arrangement onto a plurality of nozzles 21 arranged on a head 20, the operation is repeated of fitting one or a plurality of tips 40 resting upon a tip rack 60 respectively to nozzles 21 and then removing the tips from the nozzles 21 and tentatively put those on the tentative rest 27, to thereby form a tip arrangement corresponding to the desired arrangement on the tentative rest 27, followed by fitting the plurality of tips to the plurality of nozzles 21.

### BACKGROUND OF THE INVENTION

The present invention relates to a dispensing apparatus, tip fitting method on a dispensing apparatus and dispensing method for use in dispensing a liquid in the field of drug discovery screening or the like.

The dispenser is known as an apparatus for use in systematically conducting an experiment of biochemical reaction, etc of a substance. The dispenser has a head on which a plurality of nozzles are arranged in a matrix form. The nozzles are each to be fit with a member made hollow conical at its tip end, called a “tip”. The head aspirates a liquid, such as a drug solution or a reagent, through the tips respectively fit on the nozzles, and discharges it into the wells provided in a microtiter plate. (see Patent Documents 1 and 2)

In order to fit the tips to the nozzles, positioning is made at above the tip rack where the tips previously put oriented thereon, followed by descending the head. This allows the nozzles, at lower ends, to be press-fit respectively to the tips, thus attaching at one time the tips of the tip rack onto the nozzles. Meanwhile, the tips on the nozzles are to be removed at one time by the operation of a tip removing mechanism provided at the head.

[Patent Document 1] JP-A-H7-225235

[Patent Document 2] JP-A-2002-340912

However, in the conventional dispenser, where tips are fit in a desired arrangement onto part of nozzles instead of fitting of tips to all the nozzles arranged on the head, there is a need to fit at one time tips onto the nozzles through selectively removing the tips from the tip rack and making the tips previously in the desired arrangement on the tip rack. The tips must be manually removed from the tip rack, thus lowering operation efficiency.

### SUMMARY OF TH INVENTION

Therefore, it is an object of the present invention to provide a dispensing apparatus, tip fitting method on a dispensing apparatus and dispensing method capable of fitting a plurality of tips in a desired arrangement to a plurality of nozzles arranged in a matrix form on the head.

According to the present invention, a dispensing apparatus includes: a head on which a plurality of nozzles are arranged in a matrix form; a tip removing mechanism that removes, from the nozzles, tips fit on the nozzles; a tip rack rest that rests a tip rack on which tips, unfit to the nozzles, are put in a row form; a tentative rest where the tips, removed from the nozzles, are to be put tentatively; a relative movement mechanism that moves the head relative to the tip rack and the tentative rest; and a control section that controls the relative movement mechanism and tip removing mechanism to fit and remove tips to and from nozzles; wherein, when fitting a plurality of tips in a desired arrangement onto the plurality of nozzles arranged on the head, the control section causes the head to move in a manner repeating an operation of fitting one or a plurality of tips resting upon the tip rack onto the one or a plurality of nozzles and then removing the tips from the nozzles and tentatively put those on the tentative rest, to thereby form a tip arrangement corresponding to the desired arrangement on the tentative rest, followed by moving the head so that the plurality of tips, constituting the tip arrangement formed on the tentative rest, can be fit onto the plurality of nozzles.

Additionally, when fitting one or a plurality of tips put on the tip rack to the one or a plurality of nozzles, one or a plurality of tips, positioned at an end on a row of tips put on the tip rack, are fit onto one or a plurality of nozzles positioned at an end of a row of the nozzles.

According to another aspect of the present invention, a dispensing apparatus includes: a head on which a plurality of nozzles are arranged in a matrix form; a tip removing mechanism that removes, from the nozzles, tips fit on the nozzles; a tip rack rest that rests a tip rack on which tips, unfit to the nozzles, are put in a row form; a tentative rest where the tips, removed from the nozzles, are to be put tentatively; a relative movement mechanism that moves the head relative to the tip rack and the tentative rest; and a control section that controls the relative movement mechanism and tip removing mechanism to fit and remove tips to and from nozzles; wherein, when fitting a plurality of tips onto the plurality of nozzles arranged on the head, the control section causes the head to move in a manner fitting a plurality of tips resting on the tip rack onto a plurality of particular nozzles including one or a plurality of nozzles positioned at an end on a row of the nozzles, removing the plurality of tips from the plurality of particular nozzles and tentatively putting those on the tentative rest, and then fitting the plurality of tips onto a plurality of other particular nozzles than the plurality of particular nozzles.

Additionally, tip rest holes provided in the tip rest are formed in a same layout as the nozzles arranged on the head.

Additionally, there is further comprised of a conveyance line where to convey a plate member storing therein a liquid dispensed through the nozzle fit with the tip, the tentative rest being arranged over the conveyance line.

Further, according to the present invention, on a dispensing apparatus, of fitting a plurality of tips in a desired arrangement onto a plurality of nozzles arranged in a matrix form on a head, a tip fitting method includes: a first step of forming a tip arrangement corresponding to the desired arrangement on the tentative rest by repeating a sub-step of fitting one or a plurality of tips resting on the tip rack to the one or a plurality of nozzles and then removing the tips from the nozzles and tentatively putting those on the tentative rest; and a second step of fitting a plurality of tips, constituting the tip arrangement formed on the tentative rest at the first step, onto the plurality of nozzles.

Additionally, when fitting the one or plurality of tips resting on the tip rack to the one or plurality of nozzles, one or a plurality of tips positioned at an end on a row of the tips resting on the tip rack are fit to one or a plurality of nozzles positioned at an end of a row of the nozzles.

Further, according to another aspect of the invention, on a dispensing apparatus, of fitting a plurality of tips to a plurality of nozzles arranged in a matrix form on a head, a tip fitting method includes: fitting a plurality of tips resting on a tip rack to a plurality of particular nozzles including one or a plurality of nozzles positioned at an end of a row of the nozzles; removing the tips from the plurality of particular nozzles and tentatively putting those on a tentative rest; and fitting the plurality of tips tentatively put on the tentative rest to a plurality of particular nozzles including the other nozzles than the plurality of particular nozzles.

Additionally, tip rest holes provided in the tip rest are formed in a same layout as the nozzles arranged on the head.

Additionally, there is further comprised of a conveyance line where to convey a plate member storing therein a liquid dispensed through the nozzle fit with the tip, the tentative rest being arranged over the conveyance line.

A dispensing method is characterized by: aspirating or ejecting a liquid through the tips fit on the nozzles of the head by a dispensing apparatus according to the present invention or a tip fitting method according to the invention.

With the dispensing apparatus and a tip fitting method on a dispensing apparatus according to the invention, a plurality of tips can be fit in a desired arrangement respectively onto a plurality of apparatuses arranged in a matrix form on a head. Meanwhile, with the dispensing method according to the invention, the time required for dispensing a liquid can be greatly reduced because tips can be fit in a desired arrangement respectively onto a plurality of nozzles of the head.

### BRIEF DESCRIPTION OF THE DRAWINGS

FIG. 1 is a perspective view of a dispensing apparatus according to an embodiment of the present invention.

FIG. 2 is a fragmentary magnifying perspective view showing a head and tentative rest, together with a tip rack and microtiter plate, of a dispensing apparatus according to an embodiment of the present invention.

FIG. 3 is a plan view of the dispensing head showing the arrangement of nozzles of the dispensing head according to an embodiment of the present invention.

FIGS. 4(a) and 4(b) are fragmentary side views of a dispensing apparatus showing the manner of fitting tips resting on a tip rack onto the nozzles of the dispensing head, according to an embodiment of the present invention.

FIGS. 5(a) and 5(b) are fragmentary side views of a dispensing apparatus showing the manner of ascending and descending a plate stage provided on the dispensing apparatus, according to an embodiment of the present invention.

FIGS. 6(a) and 6(b) are fragmentary side views of a dispensing apparatus showing the manner of removing the tips, fit on the nozzles, to a tentative rest by means of a tip removing mechanism, according to an embodiment of the present invention.

FIG. 7 is a plan view of a microtiter plate showing a state of producing a dilution sequence, according to an embodiment of the present invention.

FIG. 8 is a flowchart of a main routine explaining an example of dispensing head operation in producing a dilution sequence, according to an embodiment of the present invention.

FIG. 9 is a flowchart of a sub-routine, at a step S10 of the main routine flowchart, explaining an example of dispensing head operation in producing a dilution sequence, according to an embodiment of the present invention.

FIGS. 10(a) to 10(f) are fragmentary side views of the dispensing apparatus explaining a dispensing head operation corresponding to the main routine flowchart explaining an example of dispensing head operation in producing a dilution sequence, according to an embodiment of the present invention.

FIGS. 11(a) to 11(c) are fragmentary side views of the dispensing apparatus showing the manner of fitting tips respectively onto the nozzles constituting the first nozzle row of the dispensing head, according to an embodiment of the present invention.

FIGS. 12(a) to 12(c) are fragmentary side views of the dispensing apparatus showing the manner of fitting tips respectively onto the nozzles in a plurality of rows of the dispensing head, according to an embodiment of the present invention.

FIGS. 13(a) to 13(c) are fragmentary side views of the dispensing apparatus showing the manner of fitting tips respectively onto the nozzles in a plurality of rows of the dispensing head, according to an embodiment of the present invention.

FIG. 14 is a flowchart showing the procedure to form a plurality of tip rows adjacent one to another on the dispensing head, according to an embodiment of the present invention.

FIGS. 15(a) to 15(d) are fragmentary plan views of a dispensing apparatus showing the first example of dispensing head operation corresponding to the flowchart showing the procedure to form a plurality of tip rows adjacent one to another on the dispensing head, according to an embodiment of the present invention.

FIGS. 16(a) to 16(d) are fragmentary plan views of a dispensing apparatus showing the second example of dispensing head operation corresponding to the flowchart showing the procedure to form a plurality of tip rows adjacent one to another on the dispensing head, according to an embodiment of the present invention.

### DETAILED DESCRIPTION OF THE PREFERRED EMBODIMENTS

With reference to the drawings, explanation will now be made on embodiments according to the present invention.

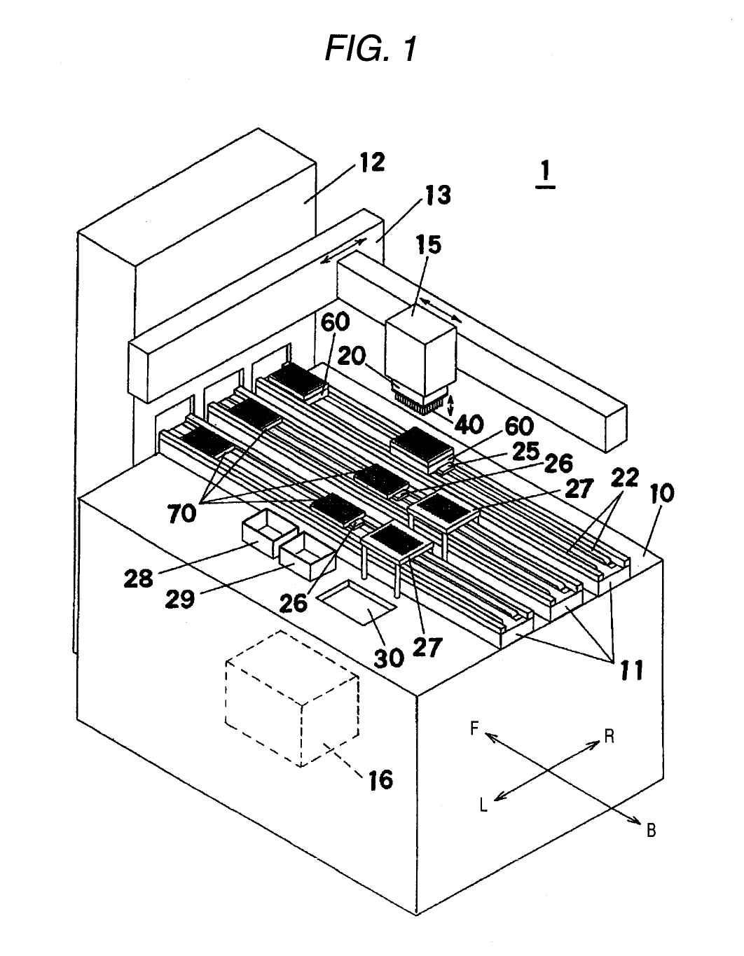

Referring first to FIGS. 1 to 6, explanation will be made on the overall construction of a dispensing apparatus 1 in the present embodiment. In FIG. 1, the dispensing apparatus 1 includes a base 10 in a box-like form, a plurality of conveyance lines 11 provided extending longitudinally of and on the upper surface of the base 10, a component supply 12 provided extending upward from the side surface of the base 10 located rear of the conveyance lines 11, a first table mechanism 13 provided fixed on the component supply 13 and extending transverse of and over the base 10, a second table mechanism 14 provided extending longitudinally of and over the base 10 from the first table mechanism 13 and movable transverse of the base 10 over the first table mechanism 13, a head support 15 arranged to move longitudinally of the base 10 over the second table mechanism 14, and a dispensing head 20 arranged to vertically move relative to the head support 15 by means of a not-shown elevation mechanism built in the head support 15. Incidentally, the first and second table mechanisms 13, 14 and the elevation mechanism built in the head support 15 are mechanisms that cause the dispensing head 20 to move relatively to the base 10 (and hence relative to a tip rack 60 and tentative rest 27, referred later), and hence those are referred to as a relative moving mechanism.

Meanwhile, a tentative rest 27 is provided striding over the conveyance line 11. Laterally of the conveyance line 11 on the base 10, there are provided a diluted solution reservoir 28 containing therein a diluted solution, a reagent reservoir 29 containing therein a reagent, and a disposal port 30 through which a diluted solution, reagent or tip 40 used are to be disposed away.

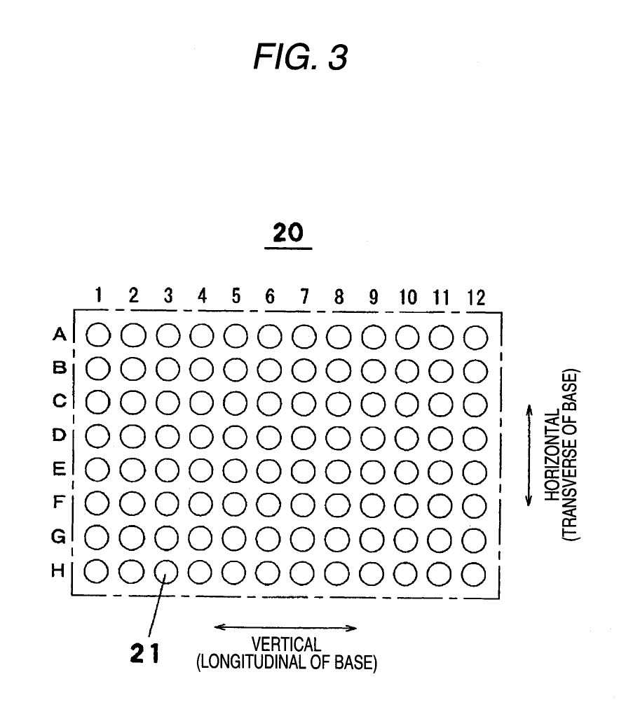

The dispensing head 20 is arranged with a plurality of nozzles 21 that are in a matrix form and project downward. In the embodiment, the nozzles 21 are arranged eight in a transverse direction of the base 10 and twelve in a longitudinal direction thereof, as shown in FIG. 3. Provided herein that the longitudinal of the base 10 on the dispensing head 20 is taken as the vertical of the dispensing head 20 while the transverse of the base 10 on the dispensing head 20 is as the horizontal of the dispensing head 20, then the dispensing head 20 is given with nozzles 21 in the number of vertically 12×horizontally 8, i.e. totally 96.

In FIG. 3, numbers 1-12 are row numbers of the nozzles 21 while alphabets A-H are identification characters on each row of the nozzles 21. From now on, the nozzle row, constituted by A-H, or eight, nozzles 21 positioned on the row numbered 1, is referred to as the “first nozzle row”, the nozzle row, constituted by A-H, or eight, nozzles 21 positioned on the row numbered 21, is as the “second nozzle row”, . . . , and the nozzle row, constituted by A-H, or eight, nozzles 21 positioned on the row numbered 12, is as the “twelfth nozzle row”.

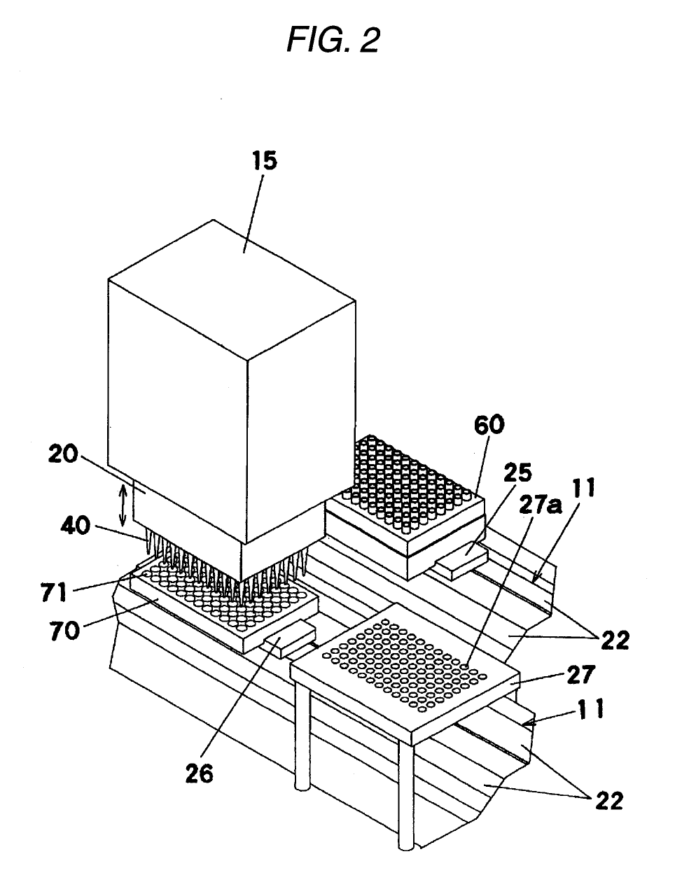

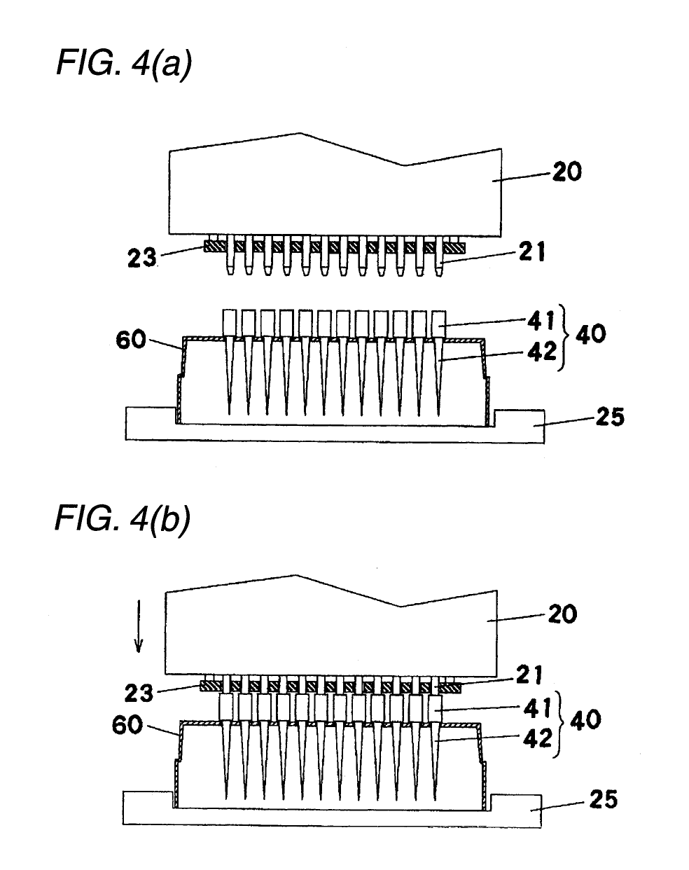

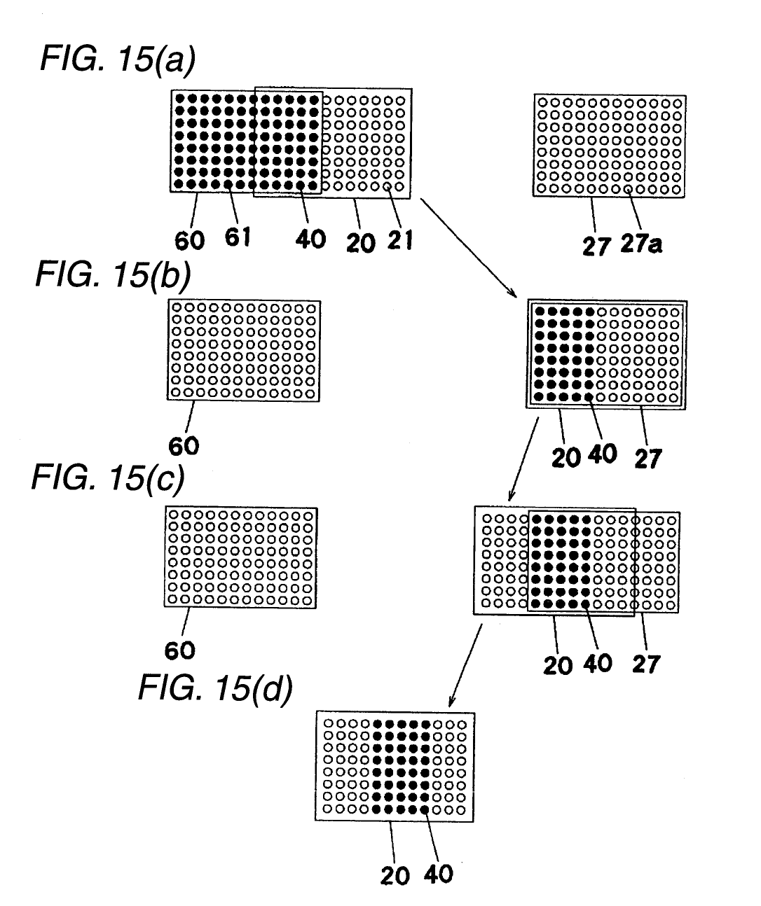

Tips 40 are removably fit respectively on the lower portions of the nozzles 21. The tip 40 has a hollow cylindrical pressure-fit portion 41 to be fit over the nozzle 21 and a hollow conical tip end portion 42 extending downward in a manner narrowing from the pressure-fit portion 41, as shown in FIG. 4. The tip 40 before fit to the nozzle 21, i.e. unused, is supplied in the state resting on a tip rack 60. The tip rack 60 is a box-like member as shown in FIGS. 1 and 2, having an upper surface formed with tip rest holes 61 in a matrix form to put the tips 40 in a raised state (see FIG. 15).

The tip 40 unused, at its tip end portion 42, is inserted in the tip rest hole 61 from above and put in a manner opening upward at the pressure-fit portion 41. In the embodiment, the tip rest holes 61 of the tip rack 60 are provided identical in layout (in a matrix form of vertically 12×horizontally 8) to the nozzles 21 of the dispensing head 20. For this reason, from now on, the tip rest holes 61 are referred, in position, similarly to the nozzles 21 shown in FIG. 3. The tip-rest-hole row, constituted by A-H, or eight, tip rest holes 61 positioned on the row numbered 1, is referred to as the “first tip-rest-hole row”, the tip-rest-hole row, constituted by A-H, or eight, tip rest holes 61 positioned on the row numbered 2, is as the “second tip-rest-hole row”, . . . , and the tip-rest-hole row, constituted by A-H, or eight, tip rest holes 61 positioned on the row numbered 12, is as the “twelfth tip-rest-hole row”.

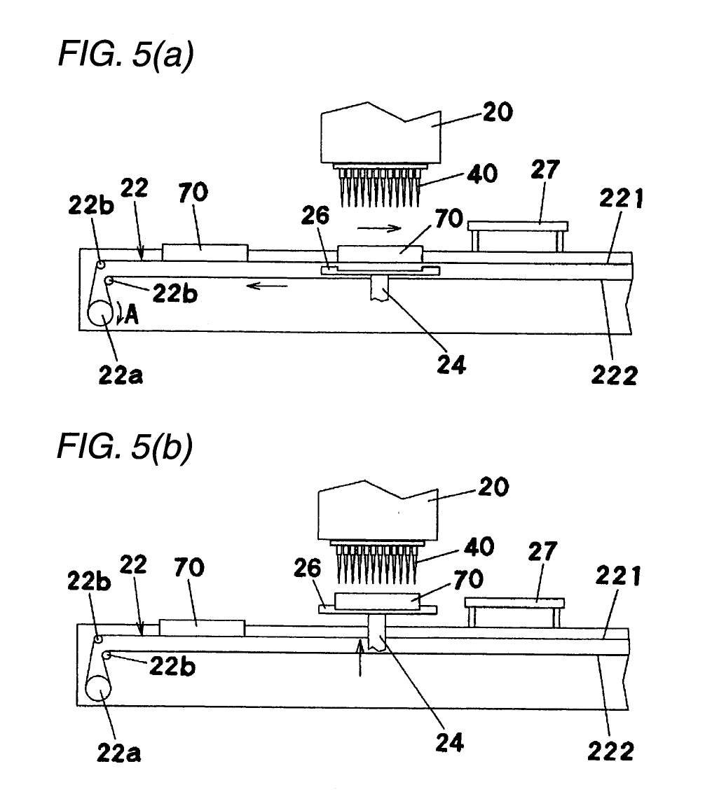

For each of the conveyance lines 11 provided on the base 10, a pair of pulleys 22a are arranged in positions in the front and back of the base 10. Two belts 22 are stretched over the one pair of pulleys 22a through a plurality of tensioners 22b (see FIGS. 1 and 5). The two belts 22 are provided parallel with each other with a spacing with respect to the transverse direction. Between the belts 22, a lift 24, referred later, is allowed to ascend and descend. The pulleys 22a are to rotate in a direction of the arrow “A” shown in FIG. 5(a). This allows the belt 22 wound over the pulleys 22a to move at its upper portion (referred to as the upper-side belt 221) in a direction of from the rear to the front of the base 10 and at its lower portion (referred to as the lower-side belt 222) in a direction of from the front to the rear of the base 10. Note that FIG. 5 shows only one pulley 22a provided in the rear of the base 10.

A lift 24 is provided intermediately of the conveyance line 11, that vertically extends to ascend and descend at between the two belts 22 (see FIG. 5). At the upper end of the lift 24, there is provided a rack stage (tip-rack rest) 25 to rest a tip rack 60 thereon or a plate stage 26 to rest a microtiter plate (plate member) 70 thereon (see FIGS. 1 and 2).

The plate stage 26 has a transverse dimension, with respect to the base 10, given smaller than the spacing between the two belts 22, so that it usually lies in a position between the upper-side belt 221 and the lower-side belt 222 (see FIG. 5(a)). However, when raised by the lift 24, it can take a position above the upper-side belt 221 so that the microtiter plate 70 conveyed by the belts 22 can be held lifted in a manner spaced from the upper surface of the upper-side belt 221 (see FIG. 5(b)). The rack stage 25 is structured similarly to the plate stage 26 so that the tip rack 60 supplied from the component supply 12 and conveyed through the belts 22 can be held lifted in a manner spaced from the upper surface of the upper-side belt 221.

When to fit the tips 40 respectively onto the nozzles 21 of the dispensing head 20, the dispensing head 20 is positioned above the tip rack 60 rested with tips 40 or the tentative rest 27 as shown in FIG. 4(a). The dispensing head 20 is descended relative to the head support 15, in the state the nozzles 21 are vertically opposed respectively to the tips 40 that are to fit to the nozzles 21. Due to this, the nozzles 21 are respectively pressure-fit in the pressure-fit portions 41 of the tips 40 from above as shown in FIG. 4(b). Thus, the tips 40 are attached respectively on the nozzles 21.

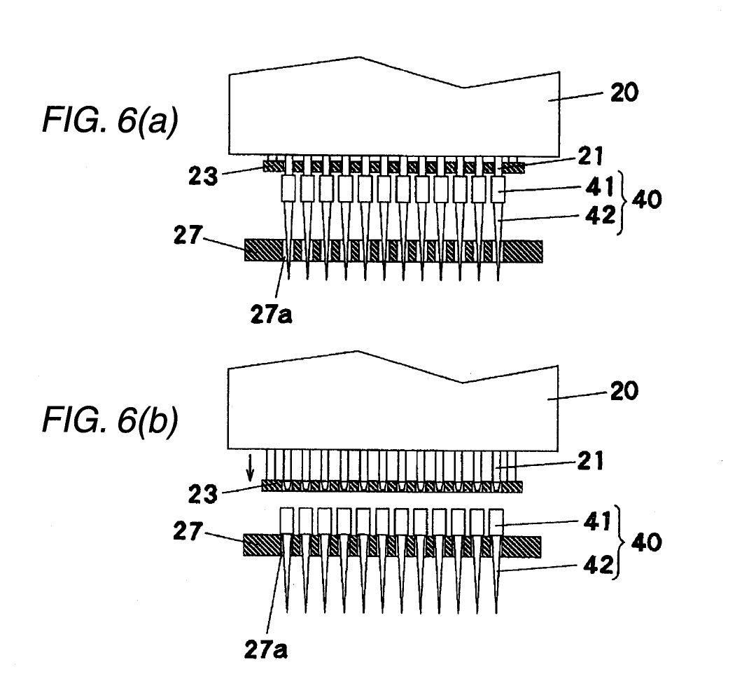

The dispensing head 20 is provided with a tip removing member 23 for removing the tips 40 on the nozzles 21 respectively from the nozzles 21. The tip removing member 23 is provided under the dispensing head 20 as shown in FIG. 6 and to be descended by means of a not-shown tip-removing-member descending mechanism. The tip removing member 23 is positioned above the pressure-fit portions 41 of the tips 40, in the state the tips 40 are fit on the nozzles 21 (see FIG. 6(a)). However, when descended by the tip-removing-member descending mechanism, the pressure-fit portions 41 of the tips 40 is pushed down to detach the tips 40 downward respectively from the nozzles 21 (see FIG. 6(B)). Incidentally, the tip removing member 23 and the tip-removing-member descending mechanism constitute a mechanism to remove the tips 40 fit on the nozzles 21 from those nozzles, and hence those are referred to as a tip removing mechanism from now on.

The tentative rest 27 is provided in a position frontward of the plate stage 26, over the conveyance line 11 where to transport the microtiter plate 70. The tentative rest 27 serves as a site where the tips 40 once fit on the nozzles 21 are removed therefrom and rested tentatively. The tips 40 are respectively inserted from above and rested tentatively in the tentative rest holes 27a (see FIG. 2) formed in the upper surface of the tentative rest 27. In the embodiment, the tentative rest holes 27a of the tentative rest 27 are provided identical in layout (in a matrix form of vertically 12×horizontally 8) to the nozzles 21 of the dispensing head 20. For this reason, from now on, the tentative rest holes 27a are referred, in position, similarly to the nozzles 21 shown in FIG. 3. The tentative-rest-hole row, constituted by A-H, or eight, tentative rest holes 61 positioned on the row numbered 1, is referred to as the “first tentative-rest-hole row”, the tentative-rest-hole row, constituted by A-H, or eight, tip rest holes 61 positioned on the row numbered 2, is as the “second tentative-rest-hole row”, . . . , and the tentative-rest-hole row, constituted by A-H, or eight, tentative rest holes 61 positioned on the row numbered 12, is as the “twelfth tentative-rest-hole row”.

The microtiter plate 70 is a plate-like member having a plurality of wells 71 to store therein a liquid, such as a reagent, a diluted solution or a reagent weakened with a diluted solution (hereinafter referred to as a diluted reagent). The microtiter plate 70 is supplied on the conveyance line 11 and conveyed reaching a position above the plate stage 26. In a position the belts 22 are ceased from moving, the microtiter plate 70 is held lifted by the plate stage 26.

In the embodiment, the wells 71 of the microtiter plate 70 are provided identical in layout (in a matrix form of vertically 12×horizontally 8) to the nozzles 21 of the dispensing head 20. For this reason, from now on, the wells 71 are referred, in position, similarly to the nozzles 21 shown in FIG. 3. The well row, constituted by A-H, or eight, wells 71 positioned on the row numbered 1, is referred to as the “first well row”, the well row, constituted by A-H, or eight, wells 71 positioned on the row numbered 2, is as the “second well row”, . . . , and the well row, constituted by A-H, or eight, wells 71 positioned on the row numbered 12, is as the “twelfth well row”.

As shown in FIG. 1, a control unit 16 is provided in the base 10. The control unit 16 is to perform various operations through a not-shown actuator, e.g. moving the dispensing head 20, operating the tip removing mechanism, driving and stopping the belts 22 over the conveyance line 11, ascending/descending the lift 24 and aspirating/ejecting a liquid by means of the nozzles 21.

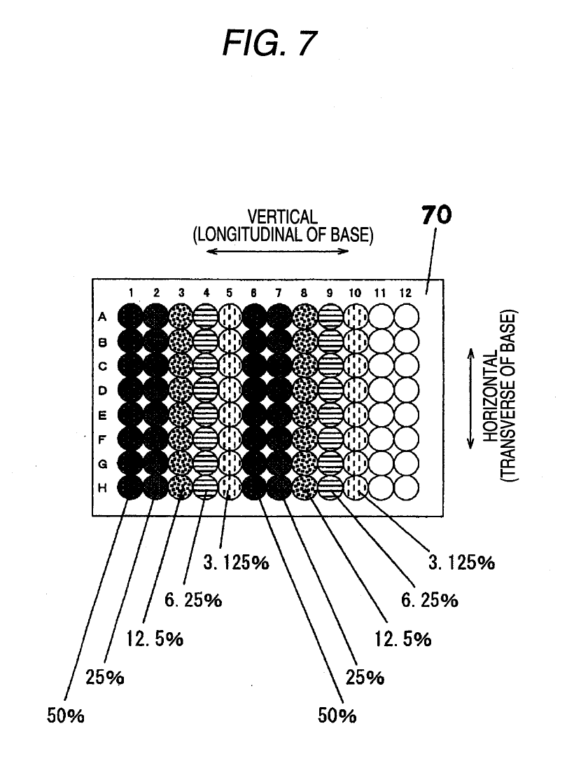

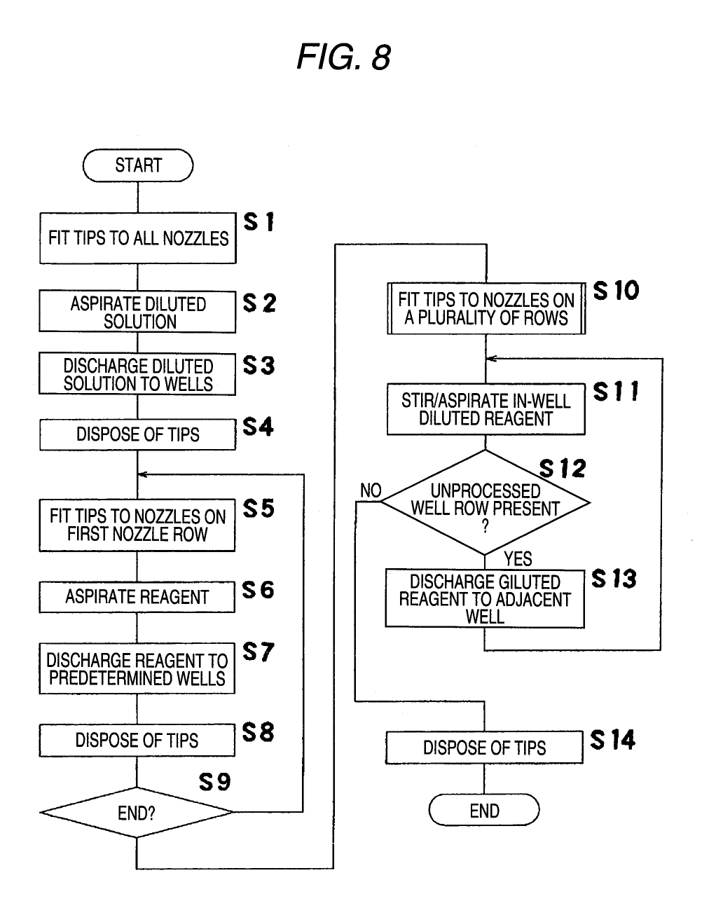

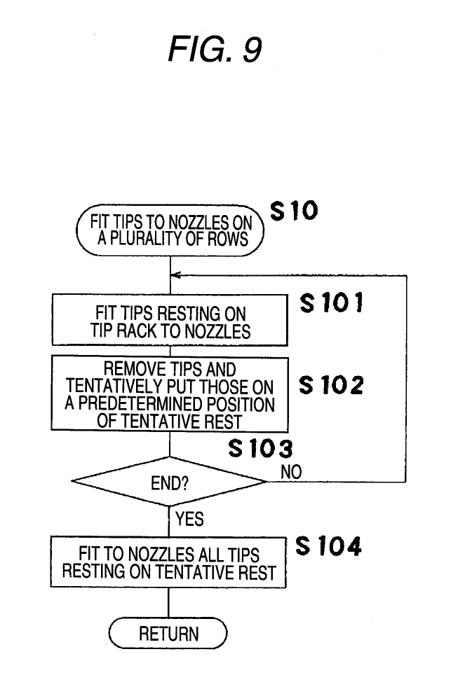

Referring to FIGS. 7 to 16, explanation is now made on the operation of the dispensing apparatus 1. Dispensing operation is first explained herein based on an example to form a dilution sequence shown in FIG. 7 on a microtiter plate 70. In this example, the control unit 16 controls the relative control mechanism, the tip removing mechanism, etc. according to the flowchart shown in FIGS. 8 and 9. This produces a diluted reagent with a concentration of 50% in the wells 71 constituting the first and sixth well rows of the microtiter plate 70, a diluted reagent with a concentration of 25% in the wells 71 constituting the second and seventh well rows, a diluted reagent with a concentration of 12.5% in the wells 71 constituting the third and eighth well rows, a diluted reagent with a concentration of 6.25% in the wells 71 constituting the fourth and ninth well rows, and a diluted reagent with a concentration of 3.125% in the wells 71 constituting the fifth and tenth well rows.

In order to produce such a dilution sequence on the microtiter plate 70, the control unit 16 takes control according to a main-routine flowchart shown in FIG. 8. In the controlling, tips 40 are fit respectively onto all the nozzles 21 provided vertically 12×horizontally 8, i.e. totally 96 in the number on the dispensing head 20 (step S1). This step is performed as follow. The dispensing head 20 is moved to the immediately above of the tip rack 60, rested with tips 40 unused, that is supplied over the conveyance line 11 and held lifted by the rack stage 25. Then, the dispensing head 20, in a state placing vertically opposite the nozzles 21 constituting the first to twelfth nozzle rows of the dispensing head 20 and the tip rest holes 61 constituting the first to twelfth tip-rest-hole rows of the tip rack 60 at those identical in row number and identification reference, is descended. Thus, the nozzles 21 are press fit to the tips 40 positioned immediately beneath thereof (see FIG. 4).

After completing the step S1, the diluted liquid is aspirated (step S2). This step is performed by allowing the nozzles 21 to aspirate the diluted solution, through moving the dispensing head 20 to the above of the diluted-liquid reservoir 28 and then descending the dispensing head 20 to submerge the lower ends of the tips 40 in the diluted liquid. Due to this, a constant amount (assumed 5 μL, in this case) of diluted solution is reserved in every tip 40.

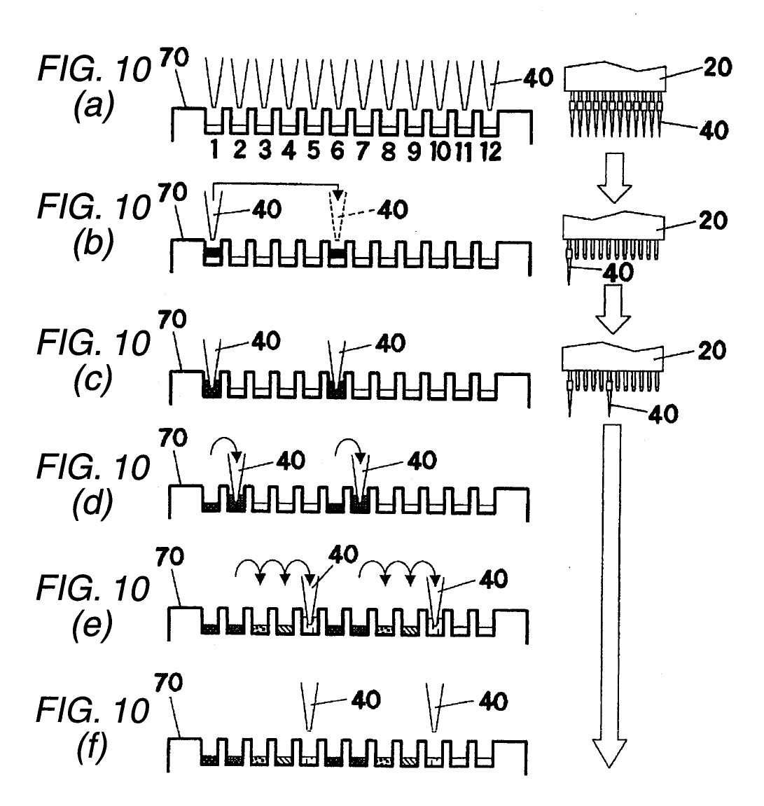

After completing the step S2, the diluted solution aspirated in the nozzles 21 at the step S2 is discharged to the well 71 (step S3). This step is performed by moving the dispensing head 20 to the immediate above of an unused microtiter plate 70 that is supplied on the conveyance line 11 and held lifted by the plate stage 26, and then discharging the diluted solution from the tips 40 respectively into the wells 71 positioned immediately beneath the tips 40 in a state placing vertically opposite the nozzles 21 constituting the first to twelfth nozzle rows of the dispensing head 20 and the wells 71 constituting the first to twelfth well rows of the microtiter plate 70 at those identical in row number and identification reference (see FIG. 10(a)). Due to this, a constant amount (assumed 5 μL, in this case) of diluted solution is reserved in every well 71.

After completing the step S3, the tips 40 are removed and disposed away (step S4). This step is performed by moving the dispensing head 20 to the above of the disposal port 30 and removing all the tips 40 at one time through operating the tip removing mechanism from the control unit 16. Due to this, all the tips 40 in the number of 96 attached on the nozzles 21 are disposed away, together with the diluted solution remaining in the tips 40.

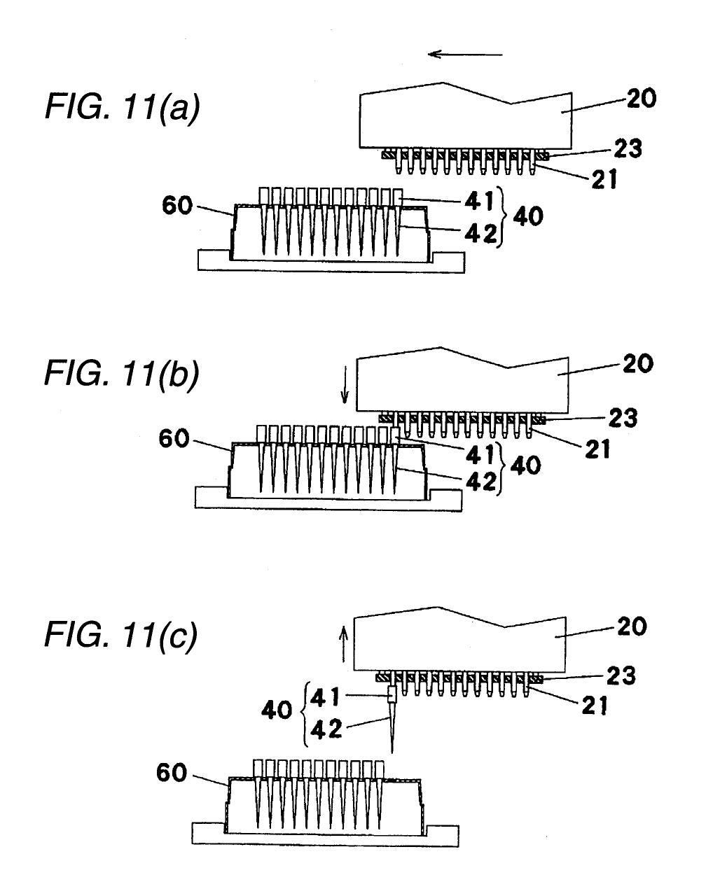

After completing the step S4, the tips 40 are fit respectively onto the nozzles 21A-H constituting the first nozzle row of the dispensing head 20 (step S5). This step is performed (see FIG. 11(b)) by moving the dispensing head 20 to the above of the tip rack 60 that is newly supplied on the conveyance line 11 and held lift by the rack stage 25, and then pressure-fit the nozzles 21 respectively in the tips 40 resting in the immediately-below tip rest holes 61 through descending the dispensing head 20 in a state placing vertically opposite the nozzles 21A-H constituting the first nozzle row of the dispensing head 20 and the tip rest holes 61A-H constituting the twelfth tip-rest-hole row of the tip rack 60 at those identical in identification reference (see FIG. 11(a)). After pressure-fitting the nozzles 21 in the tips 40, the dispensing head 40 is ascended (see FIG. 11(c)).

After completing the step S5, the reagent is aspirated (step S6). This step is performed by allowing the nozzles 21 to aspirate the reagent, through moving the dispensing head 20 to the above of the reagent reservoir 29 and then descending the dispensing head 20 to submerge the lower ends of the tips 40 in the reagent. Due to this, a constant amount (assumed 5 μL, in this case) of reagent is reserved in each of the eight tips 40 attached on the nozzles 21A-H constituting the first nozzle row of the dispensing head 20.

After completing the step S6, the reagent is discharged to predetermined wells 71 (step S7). The “predetermined wells 71” refer to the eight wells 71A-H constituting the first well row of the microtiter plate 70 as well as the eight wells 71A-H constituting the sixth well row of the microtiter plate 70. In the first round of step S7, those means the wells 71A-H constituting the first well row of the microtiter plate 70. This step is performed by moving the dispensing head 20 to the above of the foregoing microtiter plate 70 and discharging the reagent of the tips 40 fit on the nozzles 21 respectively into the wells 71 positioned immediately beneath thereof in a state placing vertically opposite the nozzles 21A-H constituting the first nozzle row of the dispensing head 20 and the wells 71A-H constituting the first well row of the microtiter plate 70 at those identical in identification reference (see the solid-lined tip 40 in FIG. 10(b)). This produces a diluted reagent with a concentration 50% in an amount of 10 μL in the wells A-H constituting the first well row of the microtiter plate 70.

After completing the step S7, the tips 40 are removed and disposed away (step S8). This step is performed by moving the dispensing head 20 to the above of the disposal port 30 and removing at one time all the tips 40 attached on the nozzles 21. Due to this, the eight tips 40, attached on the nozzles 21A-H constituting the first nozzle row of the dispensing head 20, are disposed away together with the reagent remaining in the tips 40.

After completing the step S8, determination is made as to whether or not the reagent is completely discharged to all the predetermined wells 71 (step S9). When the reagent is completely discharged to all the predetermined wells 71, the process proceeds to step S10. When the reagent is not completely discharged to all the predetermined wells 71, the process returns to the step S5. Herein, because the reagent is not completely discharged to the wells 71A-H constituting the sixth well row of the microtiter plate 70, the process returns to the step S5. Similarly to the last-round step S5, the tips 40 are fit onto the nozzles 21A-H constituting the first nozzle row of the dispensing head 20 (step S5 in the second round).

After completing the step S5 in the second round, the reagent is aspirated (step S6 in the second round). This step is performed similarly in procedure to the step S6 in the first round. Due to this, a constant amount (assumed 5 μL, in this case) of reagent is reserved in each of the eight tips 40 attached on the nozzles 21A-H constituting the first nozzle row of the dispensing head 20.

After completing the step S6 in the second round, the reagent is discharged to predetermined wells 71 (step S7 in the second round). The “predetermined wells 71”, at the second-round step S7, mean the eight wells 71A-H constituting the sixth well row of the microtiter plate 70. This step is performed by moving the dispensing head 20 to the above of the microtiter plate 70 and discharging the reagent of the tips 40 fit on the nozzles 21 respectively to the wells 71 positioned immediately beneath the tips 40 in a state placing vertically opposite the nozzles 21A-H constituting the first row of the dispensing head 20 and the wells 71A-H constituting the sixth well row of the microtiter plate 70 at those identical in identification reference (see the broken-lined tip 40 in FIG. 10(b)). This produces a diluted reagent with a concentration 50% in an amount of 10 μL also in the wells A-H constituting the sixth well row of the microtiter plate 70.

After completing the step S7 in the second round, the tips 40 are removed and disposed away (step S8 in the second round). This step is performed similarly in procedure to the first-round step S8. Due to this, the eight tips 40, attached on the nozzles 21A-H constituting the first nozzle row of the dispensing head 20, are disposed away together with the reagent remaining in the tips 40.

After completing the step S8 in the second round, determination is made as to whether or not the reagent is completely discharged to all the predetermined wells 71 (step S9 in the second round). Herein, because the reagent is completely discharged to the wells 71A-H constituting the first well row of the microtiter plate 70 as well as to the wells 71A-H constituting the sixth well row of the microtiter plate 70, the process proceeds to step S10.

At the step S110, a “tip arrangement having two tip rows spaced an amount of four tip rows” is formed in the dispensing head 20. Specifically, tips 40 are fit respectively to the nozzles 21A-H constituting the first nozzle row of the dispensing head 20 as well as to the nozzles 21A-H constituting the sixth nozzle row of the dispensing head 20. This step is in one form of a step to fit a plurality of tips 40 in a predetermined arrangement onto a plurality of nozzles 21 arranged in a matrix form on the dispensing head 20. By repeating the operation of fitting one or a plurality of tips 40 of the tip rack 60 onto one or a plurality of nozzles 21 and removing the tip 40 and tentatively put it on the tentative rest 27 (corresponding to the steps S101-S103, referred later), a tip arrangement corresponding to the desired arrangement is formed on the tentative rest 27. Then, the plurality of tips 40 in the tip arrangement are fit to the nozzles 21 of the dispensing head 20 (corresponding to step S104, hereinafter referred).

In the step S10, the tips 40 on the tip rack 60 are first fit to the nozzles 21 of the dispensing head 20, in the subroutine flowchart shown in FIG. 9 (step S101). This step is performed by moving the dispensing head 20 to the above of the tip rack 60 that is newly supplied on the conveyance line 11 and held lift by the rack stage 25, and then pressure-fitting the nozzles 21 respectively in the tips 40 resting in the immediately-below tip rest holes 61 through descending the dispensing head 20 in a state placing vertically opposite the nozzles 21A-H constituting the first nozzle row of the dispensing head 20 and the tip rest holes 61A-H constituting the first tip-rest-hole row of the tip rack 60 at those identical in identification reference.

After completing the step S101, the tips 40 are removed and tentatively put on a predetermined position of the tentative rest 27 (step S102). The “predetermined position” refers to the tentative rest holes 27aA-H constituting the first tentative-rest-hole row of the tentative rest 27 as well as the tentative rest holes 27aA-H constituting the sixth tentative-rest-hole row of the tentative rest 27. At the step S102 in the first round, it means the tentative rest holes 27aA-H constituting the first tentative-rest-hole row of the tentative rest 27. This step is performed by moving the dispensing head 20 to the above of the tentative rest 27 and removing at one time the tips 40, attached on the nozzles 21A-H constituting the first nozzle row of the dispensing head 20, in a state placing vertically opposite the nozzles 21A-H constituting the first nozzle row of the dispensing head 20 and the tentative rest holes 27aA-H constituting the first tentative-rest-hole row of the tentative rest 27 at those identical in identification reference (see FIG. 4). Due to this, the eight tips 40, removed from the dispensing head 20, are tentatively put in the tentative rest holes 27aA-H constituting the first tentative-rest-hole row of the tentative rest 27.

After completing the step S102, determination is made as to whether or not the tips 40 have been tentatively put completely in all the predetermined position of the tentative rest 27 (step S103). When the tips 40 have been tentatively put completely in all the predetermined position of the tentative rest 27, the process proceeds to step S104. When the tips 40 have not been tentatively put completely in all the predetermined position of the tentative rest 27, the process returns to the step S101. Herein, because the tips 40 have not been tentatively put in the tentative rest holes 27a constituting the sixth tentative-rest-hole row of the tentative rest 27, the process returns to the step S101. Similarly to the step S5 in the last round, the tips 40 are fit onto the nozzles 21A-H constituting the first nozzle row of the dispensing head 20 (step S101 in the second round). Incidentally, at the step S101 in the second round, the tips 40 A-H, resting in the tip rest holes constituting the eleventh tip-rest-hole row of the tip rack 60, are fit respectively onto the nozzles 21A-H constituting the first nozzle row of the dispensing head 20.

After completing the step S101 in the second round, the tips 40 are removed and tentatively put on a predetermined position of the tentative rest 27 (step S102 in the second round). The “predetermined position”, in the second-round step S102, refers to the tentative rest holes 27aA-H constituting the sixth tentative-rest-hole row of the tentative rest 27. This step is performed by moving the dispensing head 20 to the above of the tentative rest 27 and removing at one time all the tips 40, attached on the nozzles 21A-H constituting the first nozzle row of the dispensing head 20, in a state placing vertically opposite the eight tips 40 fit on the nozzles 21A-H constituting the first nozzle row of the dispensing head 20 and the sixth tentative rest holes 27a of the tentative rest 27 at those identical in identification reference. Due to this, the tips 40 are tentatively put in the tentative rest holes 27aA-H constituting the sixth tentative-rest-hole row of the tentative rest 27, in addition to those in the tentative rest holes 27aA-H constituting the first tentative-rest-hole row of the tentative rest 27.

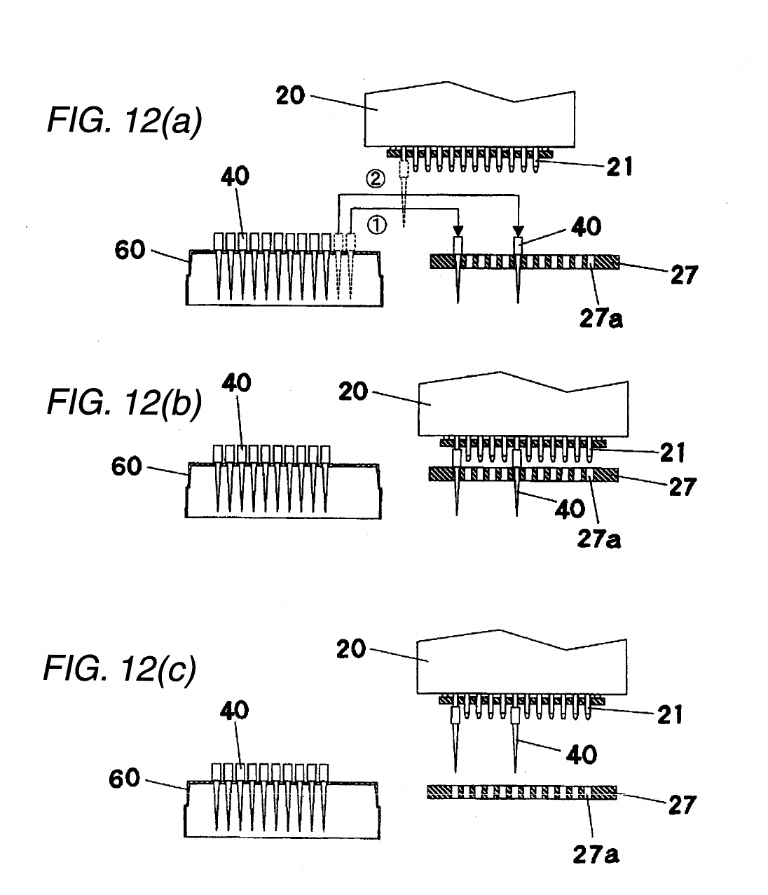

FIG. 12(a) shows a state that a tip arrangement corresponding to the desired arrangement is formed on the tentative rest 27 by repeating the steps S101-S103. The circled FIGS. 1, 2, attached on the arrows shown in the figure, are numbers representing the repeated cycles of executing the steps S101-S103. Incidentally, in the present FIG. 12(a) and hereinafter-referred FIGS. 12(b) and 12(c), the nozzles 21 extending downward of the dispensing head 20 provide the first nozzle row, the second nozzle row, . . . , the twelfth nozzle row in the leftward order of the page while the tentative rest holes formed in the tentative rest 27 provide the first tentative-rest-hole row, the second tentative-rest-hole row, . . . , the twelfth tentative-rest-hole row in the leftward order on the page.

After completing the step S102 in the second round, determination is made as to whether or not tips 40 have been tentatively put completely in a predetermined position of the tentative rest 27 (step S103). Because tips 40 have already been tentatively put in the tentative rest holes 27aA-H constituting the first tentative-rest-hole row of the tentative rest 27 as well as in the tentative rest holes 27aA-H constituting the sixth tentative-rest-hole row of the tentative rest 27, the process proceeds to the next step S104.

In the step S104, all the tips 40 on the tentative rest 27 are fit onto the nozzles 21 of the dispensing head 20. This process is performed by descending the dispensing head 20 in a state placing vertically opposite the nozzles 21 constituting the first to twelfth nozzle rows of the dispensing head 20 and the tentative rest holes 27a constituting the first to twelfth tentative-rest-hole rows of the tentative rest 27 at those identical in row number and identification reference, and pressure-fitting the nozzles 21A-H constituting the first nozzle row of the dispensing head 20 respectively to the tips 40 tentatively put in the tentative rest holes 27a positioned immediately beneath thereof as well as the nozzles 21A-H constituting the sixth nozzle row of the dispensing head 20 respectively to the tips 40 tentatively put in the tentative rest holes 27a positioned immediately beneath thereof. Due to this, the tips 60, formed in a tip arrangement corresponding to the desired arrangement on the tentative rest 27, are fit at one time respectively onto the nozzles 21 of the dispensing head 20 (see FIG. 12(b)).

After pressure-fitting the tips 40 to the nozzles 21, the dispensing head 40 is raised up (see FIGS. 12(c)). By the step S104, the tips 40 in plurality are fit, in a desired arrangement, to the plurality of nozzles 21 arranged on the dispensing head 20. After completing the step S105, the process leaves the subroutine and terminates the steps S10 in the main routine.

After completing the step S110 on the main routine, the diluted reagent in the well 71 is stirred and aspirated (step S11). In this step, the dispensing head 20 is moved to the above of the microtiter plate 70, to place vertically opposite the nozzles 21 constituting the first nozzle row of the dispensing head 20 and the wells 71A-H constituting the first well row of the microtiter plate 70 at those identical in identification reference, and to place vertically opposite the nozzles 21 constituting the sixth nozzle row of the dispensing head 20 and the wells 71A-H constituting the sixth well row of the microtiter plate 70 at those identical in identification reference. Then, the dispensing head 20 is descended to submerge the lower end of the tip 40 attached on the nozzle 21 into the diluted liquid of the well positioned immediately beneath thereof, thereby stirring the diluted reagent (see FIG. 10(c)). Incidentally, stirring the diluted reagent is by repeated aspiration and dispense into and from the tip 40 in a manner uniformly immixing the reagent and the diluted solution together.

Then, by the nozzle 21A-H constituting the first nozzle row of the dispensing head 20, aspirated is the diluted reagent from the well 71 positioned immediately beneath thereof Simultaneously, by the nozzle 21A-H constituting the sixth nozzle row of the dispensing head 20, aspirated is the diluted reagent from the well 71 positioned immediately beneath thereof Due to this, a constant amount (assumed 5 μL, in this case) of reagent is reserved in each of the tips 40 fit to the nozzles constituting the first and sixth nozzle rows of the of the dispensing head 20.

After completing the step S11, determination is made as to whether there is present/absent an unprocessed well row (step S12). If there is present an unprocessed well row, the process proceeds to step S13. If there is not present an unprocessed well row, the process proceeds to step S14. While the process is not completed as to the second to fifth well rows and the seventh to tenth well rows, the process proceeds to the step S13 after the determination at the step S12.

At the step S13, the diluted reagent is discharged to the adjacent well 71 (see FIGS. 10(d) and 10(e)). By the process, a diluted reagent is produced in the adjacent well 21, in order, at a half concentration of that in the former well 21. Meanwhile, at the step S14, the last-aspirated diluted reagent (amount: 5 μL), of from the wells 71 constituting the fifth and tenth well rows, is disposed together with the tips 40, through the disposal port 30. Completing the step S14, the process leaves the main routine and terminates the dispensing operation.

By executing the steps of the dispensing operation on the dispensing apparatus 1, a dilution sequence targeted can be formed on a microtiter plate 70. However, the present dispensing apparatus 1, at the step S110, is to fit a plurality of tips 40 desirably in arrangement onto a plurality of nozzles 21 that are in a matrix arrangement on the dispensing head 20. In this case, after fitting a plurality (one row, in the above embodiment) of tips 40 of the tip rack 60 onto a plurality (one row, in the above embodiment) of nozzles 21 of the dispensing head 20, the tips 40 are removed from the nozzles 21 and tentatively put on the tentative rest 27, which operation is operated. Due to this, after forming a tip arrangement correspondingly to the desired arrangement on the tentative rest 27, a plurality (two rows, in the above embodiment) of tips 40 configuring the tip arrangement on the tentative rest 27 are respectively fit onto a plurality (two rows, in the above embodiment) of nozzles 21 of the dispensing head 20. Accordingly, the dispensing apparatus 1 of the invention can fit a plurality of tips 40 desirably in arrangement to a plurality of nozzles 21 arranged in a matrix form on the dispensing head 20 without requiring the step of selectively removing the tips manually from the tip rack as necessitated in the conventional.

Meanwhile, according to the dispensing method that aspirates and discharges a liquid through the tips 40 fit on the nozzles 21 of the dispensing head 20 by means of the present dispensing apparatus 1 and the tip fitting method on the present dispensing apparatus 1, the time required in liquid dispense can be reduced greatly. The step of preparing a dilution sequence, if not done swiftly, problematically causes a change of concentration through evaporation. Hence, the time reduction effect based on the dispensing method can be considered significantly valuable.

In the present dispensing apparatus 1, because the tentative rest 27 is arranged over the conveyance line 11, the dispensing head 20 requires a smaller movement path in putting tentatively the tips 40 on the tentative rest 27. This can greatly reduce the time required to fit the tips 40 to the dispensing head 20.

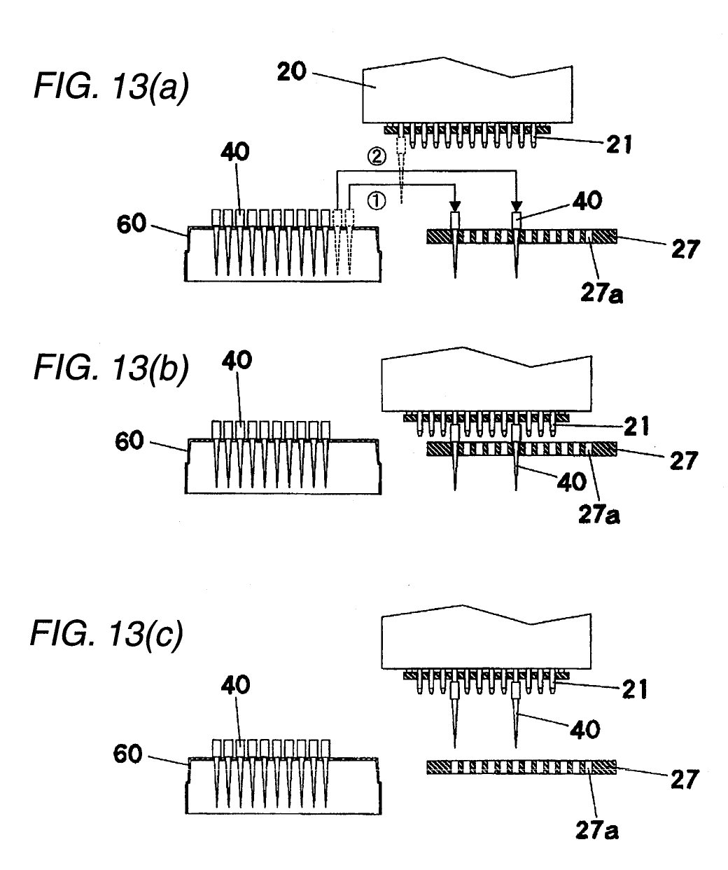

Here, in the above embodiment, at the step S104 of the FIG. 9 subroutine flowchart, the tips 40, on the tentative rest holes 27a constituting the first and sixth tentative-rest-hole rows of the tentative rest 27, are fit respectively onto the nozzles 21 constituting the first and sixth nozzle rows of the dispensing head 20. However, the dispensing head 20 may be descended to the tentative rest 27 by placing vertically opposite the nozzles 21A-H constituting the fourth nozzle row of the dispensing head 20 and the tentative rest holes 27aA-H constituting the first tentative-rest-hole row of the tentative rest 27 at those identical in identification reference and by placing vertically opposite the nozzles 21A-H constituting the ninth nozzle row of the dispensing head 20 and the tentative rest holes 27aA-H constituting the sixth tentative-rest-hole row of the tentative rest 27 at those identical in identification reference, as shown in FIG. 13. This can fit the tips 40 to the nozzles 21 constituting the ninth nozzle row of the dispensing head 20. In also this case, the dispensing head 20 is formed with a “tip arrangement having two tip rows spaced an amount of four tip rows”. Namely, the tip arrangement, previously formed on the tentative rest 27, is desirable in position on the tentative rest 27.

Incidentally, in the embodiment, the tips 40 in the number of one row on the tip rack 60 were fit respectively onto the nozzles 21 in the number of one row of the dispensing head 20 and then transferred to the tentative rest 27, in the subroutine process steps shown in FIG. 9. Alternatively, the tips 40 may be placed one by one onto the tentative rest 27 instead of placing a plurality thereof at one time. Namely, at the first-round steps S101-S103 in the FIG. 9 subroutine flowchart, one or a plurality of tips 40 on the tip rack 60 may be fit respectively to one or a plurality of nozzles 21, and then the tips 40 be removed from the nozzles 21 and put onto the tentative rest 60, which operation be repeated. Specifically, at the first-round step S101, the tip 40 in the tip rest hole 27a, denoted H or A of the twelfth tip-rest-hole row of the tip rack 60, may be fit onto the nozzle 21 denoted A or H of the first nozzle row of the dispensing head 10. Otherwise, the tip 40 in the tip rest hole 27a, denoted H or A of the first tip-rest-hole row of the tip rack 60, may be fit onto the nozzle 21 denoted A or H of the twelfth nozzle row of the dispensing head 10. By thus transferring the tips 40 one by one onto the tentative rest 27, a tip arrangement can be formed quite randomly on the dispensing head 20 instead of arranging those on a row-by-row basis as in the embodiment.

Meanwhile, in the embodiment, when fitting the nozzles 40 of the tip rack 60 onto the nozzles 21, the tips 40 positioned at the end of the tip 40 row of the tip rack 60 (e.g. tips 40 in the twelfth tip-rest-hole row) were fit to the nozzles 21 positioned at the row end of the nozzles 21 (e.g. nozzles 21A-H of the first nozzle row). However, where the tip rack 60 has tip-rest-hole rows in the number smaller than the number of nozzle rows of the dispensing head 20, the tips 40 can be fit to the intermediate ones in the nozzle 21 row. Where the tip rack 60 has tip-rest-hole rows in the number greater than the number of nozzle rows of the dispensing head 20, the tips 40 positioned intermediate on the tip 40 row of the tip rack 60 can be fit to the nozzles 21.

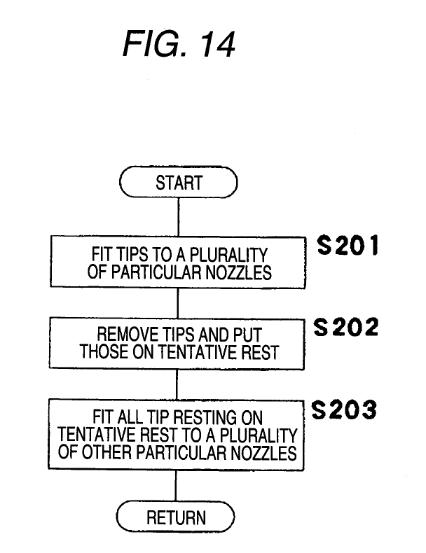

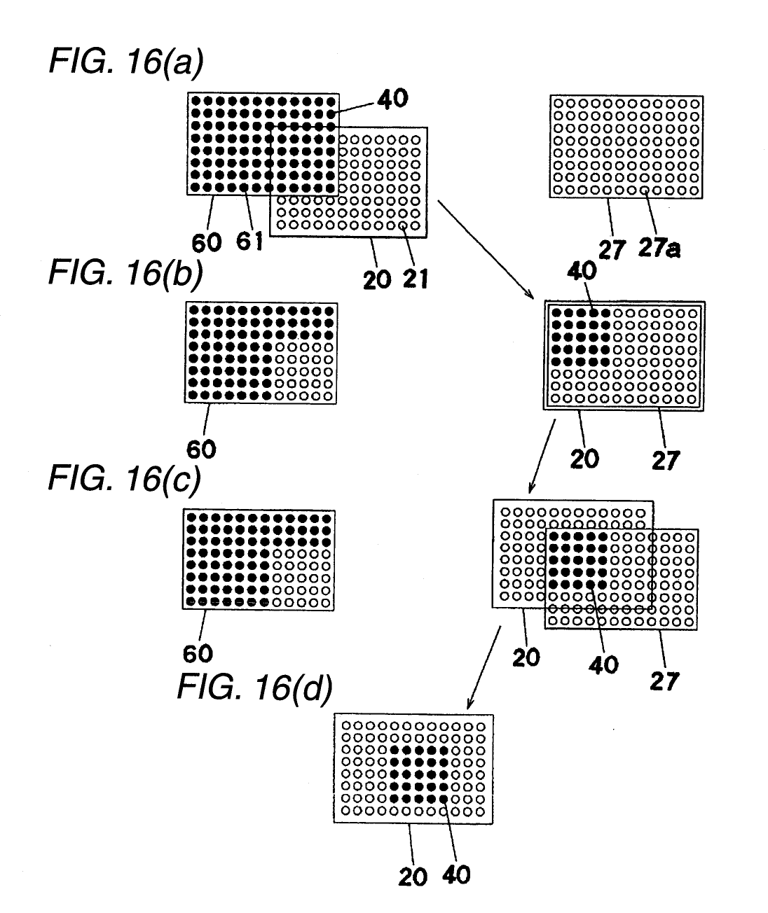

Meanwhile, in the embodiment, the tip arrangement to form on the dispensing head 20 was constituted with two tip rows spaced to each other. However, the tip arrangement to form on the dispensing head 20 is constituted by a plurality of tip rows adjacent one with another, it is possible to employ the process shown in FIGS. 14 and 15 or in FIGS. 14 and 16.

FIG. 14 is a flowchart showing the procedure to form a plurality of tip rows adjacent one with another onto the dispensing head 20, as stated in the beginning. FIG. 15 shows the first example of dispensing head operation corresponding to the FIG. 14 flowchart while FIG. 16 shows the second example of dispensing head operation corresponding to the FIG. 14 flowchart. Herein, it is assumed to form a “tip arrangement formed by fitting the tips 40 respectively to the nozzles 21 constituting the fifth to ninth nozzle rows of the dispensing head 20”. The first example shows the case to fit the tips 40 respectively to all the nozzles (A-H) constituting the fifth to ninth nozzle rows of the dispensing head 20 while the second example shows the case to fit the tips 40 respectively to part C-G of the nozzles constituting the fifth to ninth nozzle rows of the dispensing head 20. In FIGS. 15 and 16, there is typically shown a plan view of the dispensing head 20, the tip rack 60 and the tentative rest 27 wherein the black circles in the figure represent tips 40.

In the first example, tips 40 are fit respectively to a plurality of particular nozzles 21 including the nozzles 21 positioned at the ends of the nozzle 21 row arranged on the dispensing head 20 (step S201). This process is performed by moving the dispensing head 20 to the above of the tip rack 60, rested with tips 40, and descending the dispensing head 20 in a state placing vertically opposite the nozzles 21 (a plurality of particular nozzles 21) A-H on the first to fifth nozzle rows of the dispensing head 20 and the tip rest holes 61A-H on the eighth to twelfth tip-rest-hole rows of the tip rack 60 at those identical in identification reference, thereby pressure-fitting the nozzles 21 onto the tips 40 put in the tip rest holes 61 positioned immediately beneath thereof Due to this, the tips 40 are fit respectively to all the nozzles (particular nozzles 21) constituting the first to fifth nozzle rows of the dispensing head 20 (see FIG. 15(a)).

After completing the step S201, the tips 40 are removed and put on the tentative rest 27 (step S202). This process is performed by moving the dispensing head 20 to the above of the tentative rest 27, and removing at one time all the tips 40 through placing vertically opposite the nozzles 21A-H on the first to fifth nozzle rows of the dispensing head 20 and the tentative rest holes 27aA-H on the first to fifth tentative-rest-hole rows of the tentative rest 27 at those identical in identification reference. Due to this, the tips 40 are tentatively put in the tentative rest holes A-H on the first to fifth tentative-rest-hole rows of the tentative rest 27 (see FIG. 15(b)).

After completing the step S202, all the tips 40 on the tentative rest 27 are fit to a plurality of other particular nozzles (nozzles 21A-H on the fifth to ninth nozzle rows) including other nozzles than the foregoing plurality of particular nozzles (nozzles A-H on the first to fifth nozzle rows) (step S203). This process is performed by fitting at one time the tips 40, tentatively put in the tentative rest holes 27aA-H on the first to fifth tentative-rest-hole rows of the tentative rest 27, onto the nozzles 21A-H on the fifth to ninth nozzle rows of the dispensing head 20 in a state placing vertically opposite the nozzles 21A-H on the fifth to ninth nozzle rows of the dispensing head 20 and the tentative rest holes 27aA-H on the fifth to ninth tentative-rest-hole rows of the tentative rest 27 at those identical in identification reference (see FIG. 15(c)). By the step S203, the tips 40 are fit respectively to all the nozzles 21 constituting the fifth to ninth nozzle rows of the dispensing head 20 (see FIG. 15(d)).

Now the second example is explained. In also the second example, the tips 40 are first fit respectively to a plurality of particular nozzles 21 including the nozzles positioned at the ends of the row of the nozzles 21 arranged on the dispensing head 20 (step S201). This process is performed by moving the dispensing head 20 to the above of the tip rack 60 put with the tips 40, placing vertically opposite the nozzles 21 (a plurality of particular nozzles 21) A-E on the first to fifth nozzle rows of the dispensing head 20 and the tips 40 D-H in the eighth to twelfth tip-rest-hole rows of the tip rack 60, and descending the dispensing head and thereby pressure-fitting the nozzles 21 respectively to the tips 40 resting in the tip rest holes 61 positioned immediately beneath thereof Due to this, the tips 40 are fit respectively to the nozzles (plurality of particular nozzles 21) on the first to fifth nozzle rows of the dispensing head 20 (see FIG. 16(a)).

After completing the step S201, the tips 40 are removed and put on the tentative rest 27 (step S202). This step is performed by moving the dispensing head 20 to the above of the tentative rest 27 and removing at one time all the tips 40 through placing vertically opposite the nozzles 21A-E constituting the first to fifth nozzle rows of the dispensing head 20 and the tentative rest holes 27aA-E constituting the first to fifth tentative-rest-hole rows of the tentative rest 27. Due to this, the tips 40 are tentatively put in the tentative rest holes 27aA-E on the first to fifth tentative-rest-hole rows of the tentative rest 27 (see FIG. 16(b)).

After completing the step S202, all the tips 40 on the tentative rest 27 are fit respectively to a plurality of other particular nozzles (nozzles 21 C-G on the fifth to ninth nozzle rows) including other nozzles 21 than the foregoing plurality of particular nozzles (nozzles 21A-H on the first to fifth nozzle rows) (step S203). This process is performed by fitting at one time the tips 40, tentatively put in the tentative rest holes 27aA-H on the first to fifth tentative-rest-hole rows of the tentative rest 27, onto the nozzles 21C-G on the fifth to ninth nozzle rows of the dispensing head 20 after placing vertically opposite the nozzles 21C-G on the fifth to ninth nozzle rows of the dispensing head 20 and the tentative rest holes 27aA-E on the first to fifth tentative-rest-hole rows of the tentative rest 27 (see FIG. 16(c)). By the step S203, the tips 40 are fit respectively to part (C-G) of the nozzles 21 constituting the fifth to ninth nozzle rows of the dispensing head 20 (see FIG. 16(d)).

As shown in the first and second examples, where the tip arrangement to form on the dispensing head 20 has a plurality of tip rows adjacent one to another, a plurality of tips 40 on the tip rack 60 are respectively fit to a plurality of particular nozzles 21 including one or a plurality of nozzles positioned at an end of the nozzle 21 row. Then, after removing the plurality of tips 40 from the plurality of particular nozzles and tentatively put on the tentative rest 27, the plurality of tips 40 are fit respectively to a plurality of other particular nozzles 21 including the other nozzles 21 than the foregoing plurality of particular nozzles 21 thereby simplifying the tip fit process.

Although the preferred embodiment of the invention was explained so far, the invention is not limited to the foregoing embodiment. For example, such tip arrangements shown as in the embodiment are mere one examples, e.g. “the tip arrangement having two tip rows that are spaced an amount of four tip rows” and “the tip arrangement having tips 40 fit on the nozzles 21 constituting the fifth to ninth nozzle rows of the dispensing head 20”. Another tip arrangement can be formed on the dispensing head 20. Meanwhile, besides the arrangement form nozzles 21 on the dispensing head 20, the arrangement forms on the tentative rest 27, tentative rest holes 27a and tip rack 60 as well as the arrangement form of wells 71 in the microtiter plate 70 are mere one examples. Instead of those, other arrangement forms may be provided.

According to the invention, a plurality of tips can be fit desirably in arrangement respectively to a plurality of nozzles arranged in a matrix form on a head without requiring manual operation.

This application is based upon and claims the benefit of priority of Japanese Patent Application No. 2006-141188 filed on May 22, 2006, the contents of which are incorporated herein by reference in its entirety.

What is claimed is:

1. A dispensing apparatus comprising:
a head on which a plurality of nozzles are arranged in a matrix form;
a tip removing mechanism that removes, from the nozzles, tips fit on the nozzles;
a tip rack rest that rests a tip rack on which tips, unfit to the nozzles, are put in a row form;
a tentative rest where the tips, removed from the nozzles, are to be put tentatively;
a relative movement mechanism that moves the head relative to the tip rack and the tentative rest; and
a control section that controls the relative movement mechanism and tip removing mechanism to fit and remove tips to and from nozzles;
wherein, when fitting a plurality of tips in a desired arrangement onto the plurality of nozzles arranged on the head, the control section causes the head to move in a manner repeating an operation of fitting one or a plurality of tips resting upon the tip rack onto the one or a plurality of nozzles and then removing the tips from the nozzles and tentatively put those on the tentative rest, to thereby form a tip arrangement corresponding to the desired arrangement on the tentative rest, followed by moving the head so that the plurality of tips, constituting the tip arrangement formed on the tentative rest, can be fit onto the plurality of nozzles.

2. A dispensing apparatus according to claim 1, wherein, when fitting one or a plurality of tips put on the tip rack to the one or a plurality of nozzles, one or a plurality of tips, positioned at an end on a row of tips put on the tip rack, are fit onto one or a plurality of nozzles positioned at an end of a row of the nozzles.

3. A dispensing apparatus according to claim 1, wherein tip rest holes provided in the tip rest are formed in a same layout as the nozzles arranged on the head.

4. A dispensing apparatus according to claim 1, further comprising a conveyance line where to convey a plate member storing therein a liquid dispensed through the nozzle fit with the tip, the tentative rest being arranged over the conveyance line.

5. A dispensing apparatus comprising:
a head on which a plurality of nozzles are arranged in a matrix form;
a tip removing mechanism that removes, from the nozzles, tips fit on the nozzles;
a tip rack rest that rests a tip rack on which tips, unfit to the nozzles, are put in a row form;
a tentative rest where the tips, removed from the nozzles, are to be put tentatively;
a relative movement mechanism that moves the head relative to the tip rack and the tentative rest; and
a control section that controls the relative movement mechanism and tip removing mechanism to fit and remove tips to and from nozzles;
wherein, when fitting a plurality of tips onto the plurality of nozzles arranged on the head, the control section causes the head to move in a manner fitting a plurality of tips resting on the tip rack onto a plurality of particular nozzles including one or a plurality of nozzles positioned at an end on a row of the nozzles, removing the plurality of tips from the plurality of particular nozzles and tentatively putting those on the tentative rest, and then fitting the plurality of tips onto a plurality of other particular nozzles than the plurality of particular nozzles.

6. A dispensing apparatus according to claim 5, wherein tip rest holes provided in the tip rest are formed in a same layout as the nozzles arranged on the head.

7. A dispensing apparatus according to claim 5, further comprising a conveyance line where to convey a plate member storing therein a liquid dispensed through the nozzle fit with the tip, the tentative rest being arranged over the conveyance line.

8. A tip fitting method, on a dispensing apparatus, of fitting a plurality of tips in a desired arrangement onto a plurality of nozzles arranged in a matrix form on a head, the method comprising:
a first step of forming a tip arrangement corresponding to the desired arrangement on the tentative rest by repeating a sub-step of fitting one or a plurality of tips resting on the tip rack to the one or a plurality of nozzles and then removing the tips from the nozzles and tentatively putting those on the tentative rest; and
a second step of fitting a plurality of tips, constituting the tip arrangement formed on the tentative rest at the first step, onto the plurality of nozzles.

9. A tip fitting method according to claim 8, wherein, when fitting the one or plurality of tips resting on the tip rack to the one or plurality of nozzles, one or a plurality of tips positioned at an end on a row of the tips resting on the tip rack are fit to one or a plurality of nozzles positioned at an end of a row of the nozzles.

10. A tip fitting method according to claim 8, wherein tip rest holes provided in the tip rest are formed in a same layout as the nozzles arranged on the head.

11. A tip fitting method according to claim 8, further comprising a conveyance line where to convey a plate member storing therein a liquid dispensed through the nozzle fit with the tip, the tentative rest being arranged over the conveyance line.

12. A tip fitting method, on a dispensing apparatus, of fitting a plurality of tips to a plurality of nozzles arranged in a matrix form on a head, the method comprising:
fitting a plurality of tips resting on a tip rack to a plurality of particular nozzles including one or a plurality of nozzles positioned at an end of a row of the nozzles;
removing the tips from the plurality of particular nozzles and tentatively putting those on a tentative rest; and
fitting the plurality of tips tentatively put on the tentative rest to a plurality of particular nozzles including the other nozzles than the plurality of particular nozzles.

13. A tip fitting method according to claim 12, wherein tip rest holes provided in the tip rest are formed in a same layout as the nozzles arranged on the head.

14. A tip fitting method according to claim 12, further comprising a conveyance line where to convey a plate member storing therein a liquid dispensed through the nozzle fit with the tip, the tentative rest being arranged over the conveyance line.

15. A dispensing method comprising the steps of:
fitting a plurality of tips resting upon a tip rack onto a plurality of nozzles;
removing the tips from the nozzles
tentatively putting those on a tentative rest, to thereby form a tip arrangement corresponding to a desired arrangement on the tentative rest,
moving the head so that the plurality of tips, constituting the tip arrangement formed on the tentative rest, are fit onto the plurality of nozzles and
aspirating or ejecting a liquid through the tips fit on the nozzles of the head.

16. A dispensing method comprising the steps of:
fitting a plurality of tips resting on a tip rack onto a plurality of particular nozzles including one or a plurality of nozzles positioned at an end on a row of the nozzles,
removing the plurality of tips from the plurality of particular nozzles
tentatively putting those on the tentative rest,
fitting the plurality of tips onto a plurality of other particular nozzles than the plurality of particular nozzles
aspirating or ejecting a liquid through the tips fit on the nozzles of the head.
